(19) United States
(12) Patent Application Publication
(10) Pub. No.: US 2025/0384769 A1
(43) Pub. Date: Dec. 18, 2025

(54) SYSTEM AND METHOD OF CONTROLLING VEHICLE WITH COMBINED ROUTE

(71) Applicant: Seungman Kim, McLean, VA (US)

(72) Inventor: Seungman Kim, McLean, VA (US)

(21) Appl. No.: 19/226,643

(22) Filed: Jun. 3, 2025

Related U.S. Application Data
(60) Provisional application No. 63/660,552, filed on Jun. 16, 2024.

(51) Int. Cl. G08G 1/0968; G08G 1/0967

(52) U.S. Cl. CPC G08G 1/096844; G08G 1/096725; G08G 1/096766

(57) ABSTRACT

A vehicle includes a door, an object sensing unit to sense one or more objects, a data sensing unit to wirelessly communicate with a media source to sense a data, a driving unit to operate the vehicle according to the sensed one or more objects and the sensed data, an interface to communicate with at least one of a user device and a control tower to receive an additional route, and a control unit to control the door to be open and closed at start and end points of a destination route, to add an additional route to the destination route as a combined route, to control the driving unit to operate the vehicle according to the combined route, and to control the door to be open and closed in the additional route of the combined route.

### CROSS-REFERENCE TO RELATED APPLICATIONS

This application claims the benefit of U.S. Provisional Application No. 63/660,552 filed on Jun. 16, 2024, in the U.S. Patent and Trademark Office, the entire contents of which are hereby incorporated by reference.

### BACKGROUND OF THE INVENTIVE CONCEPT

### 1. Field of the Inventive Concept

The present inventive concept relates to a system, apparatus, and method of controlling a vehicle with a combined route.

### 2. Description of the Related Art

A conventional system controls a vehicle according to sensed images. However, the conventional system is not sufficient to protect the vehicle, a user of the vehicle, and objects surrounding the vehicle.

### SUMMARY OF THE INVENTIVE CONCEPT

The present inventive concept provides a system to control a vehicle.

The present inventive concept provides an apparatus to control a vehicle.

The present inventive concept provides a method of controlling a vehicle.

The present inventive concept provides a computer readable medium to contain computer readable codes as a program to execute a method of controlling a vehicle.

Additional features and utilities of the present inventive concept will be set forth in part in the description, which follows and, in part, will be obvious from the description, or may be learned by practice of the present inventive concept.

The foregoing and/or other features and utilities of the present inventive concept may be achieved by providing a vehicle including a door, an object sensing unit to sense one or more objects, a data sensing unit to wirelessly communicate with a media source to sense a data, a driving unit to operate the vehicle according to the sensed one or more objects and the sensed data, an interface to communicate with at least one of a user device and a control tower to receive an additional route, and a control unit to control the door to be open and closed at start and end points of a destination route, to add an additional route to the destination route as a combined route, to control the driving unit to operate the vehicle according to the combined route, and to control the door to be open and closed in the additional route of the combined route.

The additional route may include a pickup point to pick up a passenger, and the door is open and closed at the pickup point.

The additional route may include a drop off point to drop off pick up a passenger, and the door is open and closed at the drop off point.

The additional route may be determined by the at least one of the user device and the control center.

A portion of the additional route may overlap a portion of the destination route.

The additional route may include a start point and an end point at least one of which is included in the destination route.

The additional route may include a start point and an end point which are off the destination route.

The control unit may control the vehicle to be returned to the destination route from the additional route.

The driving unit may control the vehicle according to at least one of the sensed objects and the sensed data.

The driving unit may control the vehicle to be temporality off and on the combined route according to at least one of the sensed objects and the sensed data.

The additional route may be combined with the destination route as the combined route according to a user input from the user device.

The additional route may be generated by the control center and determined by the user device to be added to the destination route.

Another route may be generated according to at last oner of the sensed one or more objects and the sensed data, and the control unit may add the another route to the combined route and control the driving unit to move the vehicle according to the another route.

The data may include at least one of a new traffic data, a new traffic pattern, and a new traffic line which are not included in a navigation map of the destination route and the additional route.

The one or more objects may output a signal according to a protocol such that the object sensing unit senses a state of the one or more objects according to the signal.

The media source may include at least one of a wireless station, an internet, a social media, and the control tower.

The destination route may include an end point and an arrival time of the end point, and the interface may communicate with an external deice on information of an adjusted arrival time according to the combined route.

The control unit may control the driving unit to return the vehicle to a point of the combined route from a start or end point of the additional route

The state of the door may include a door open state and a door closed state, and the driving unit may continue to operate the vehicle along a remaining portion of the combined route after recognizing completion of a starting point or an end point of the additional route according to the door open and closed states at the start and end points of the additional route.

The control unit may further control the driving unit to operate the vehicle without the state of the door in the combined route except start and end points of the additional route.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a diagram illustrating a system of controlling a vehicle according to an embodiment of the present inventive concept;

FIG. 2 is a diagram illustrating a vehicle according to an embodiment of the present inventive concept;

FIGS. 3 through 5 are diagrams illustrating a vehicle, objects, and data according to an embodiment of the present inventive concept;

FIG. 6 is a flowchart illustrating a method of controlling a vehicle according to an embodiment of the present inventive concept;

FIG. 7 is a flowchart illustrating a method of controlling a vehicle according to an embodiment of the present inventive concept;

FIGS. 8 through 12 are diagrams illustrating a route and another route with additional information according to an embodiment of the present inventive concept; and

FIG. 13 is a flowchart illustrating a method of controlling a vehicle according to an embodiment of the present inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

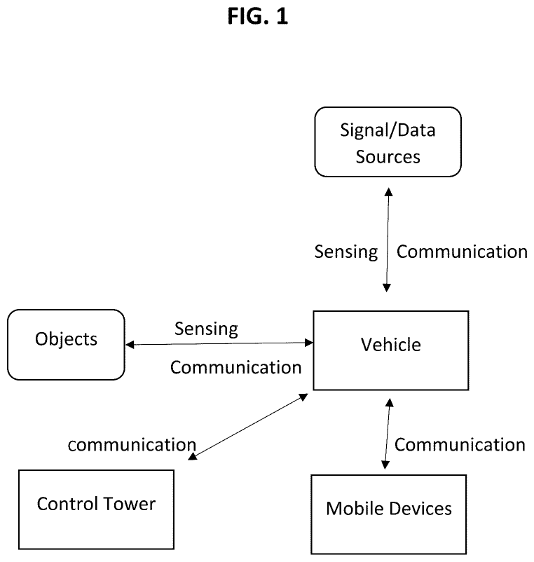

FIG. 1 is a diagram illustrating a system to control a vehicle according to an embodiment of the present inventive concept.

The system may include a vehicle. The system may further include a sensing unit to sense one or more objects around the vehicle, and a data about the one or more object. The system may include one or more signal/data sources to sense a signal or data about the one or more objects. The one or more objects and the signal or data may be referred to as an event on a route. The event may be a cause to affect or change the route. The vehicle may be a self-driving vehicle, a full-self-driving vehicle, an autonomous vehicle, a self-flying vehicle, etc. The vehicle may be driven by a human driver or an auto-pilot device to drive the vehicle without a human driver. The human driver may supervise the vehicle or may take over a control of the vehicle if necessary. It is possible that a user, passenger, or rider may not directly control the vehicle but may be given options to control the vehicle if necessary. The automatic pilot device controls the vehicle without a user driver control. The automatic pilot device may control the vehicle in the presence of the driver. The vehicle senses the one or more objects and also senses signal or data from the signal/data sources.

Here, sensing may include communications with a user device and/or a control tower. The user device may be a device of a user of the vehicle or a device of a passenger of the vehicle. The user device may be a mobile device, a smartphone, a cell phone, a laptop computer, a smart watch, and/or any device for wireless communication with the vehicle. The control tower is a control station, headquarter, or organization to communicate with the vehicle or the user device to control a destination route of the vehicle. The control tower may not be the user device. Any device other than the user device may be usable as the control tower to determine, initiate, keep and/or modify the destination route of the vehicle. The control tower may control, maintain, manage, move, or drive the vehicle. The signal/data sources may be the control tower, another station, or an authority to announce a site, e.g., car accident site, a police presence site, an emergence site, a load construction site, and any site which can affect a road condition of a driving condition of the vehicle. The signal/data sources may be an internet. The signal/data sources may be a social media. The signal/data sources may be a news and text including information on the site. The signal/data source may be a device to generate a signal to be received by a vehicle to affect a destination route of the vehicle. The vehicle and the signal/data sources may have a protocol to recognize any information on the site. The vehicle may sense the objects by using a sensor, such as a camera or a radio detector. The sensor may not detect the site since the site is out of sight or out of a sensing area around the vehicle. The site may be not seen from the vehicle.

When the vehicle compares or analyzes pieces of information from the sources on the site, it is possible that the pieces of information are not same. The pieces information may be a current car accident, a past car accident, a traffic congestion with an accident, an entire road block, a partial road block, an alternative traffic line, a new traffic pattern, a temporary road, etc. The pieces of information may affect the vehicle to be driven along the destination route. In this case, the vehicle may determine a common information or a related information of the site to control the vehicle according to the determined common information.

The controlling of the vehicle may include changing a route, changing a speed, changing an auto driving to a manual driving, communicating with a user device, etc. When a destination of the destination route is connected to a destination phone number of a user device, the vehicle may communicate with a device of the destination phone number to inform the device of the changed route, a changed arrival time, and/or a remaining time to arrive the destination. The vehicle may directly contact the device or may contact the device through the user device. The vehicle may call or send a text to the device of the destination phone number to inform the device of the device of the changed route, a changed arrival time, and/or a remaining time to arrive the destination. The user may not need to call or send a text for an arrival delay or change when the destination route is changed according to the site information.

The vehicle may communicate with a user device such as a mobile device or a cell phone, and also with a control tower which is able to control, maintain, manage, and move the vehicle. It is possible that the user device may have the same functions of the control tower. the user device may communicate with the control tower to control, maintain, manage, and move the vehicle.

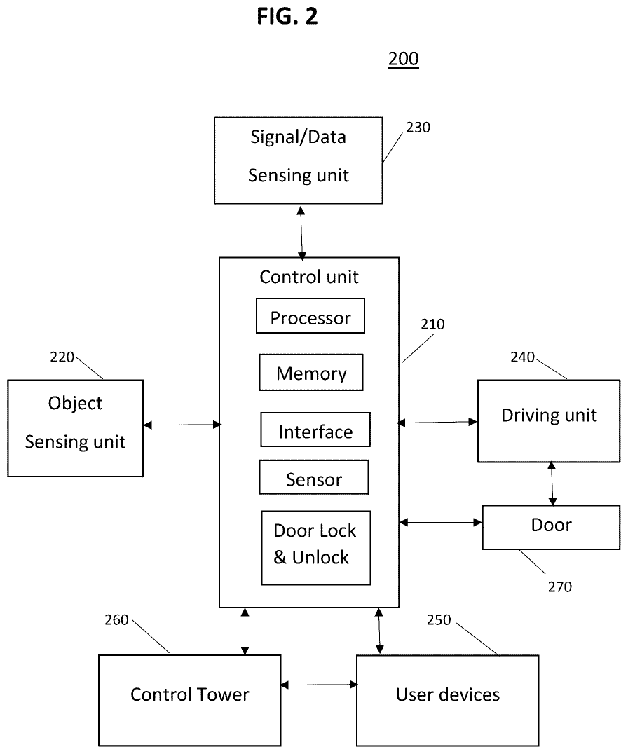

FIG. 2 is a diagram illustrating a vehicle 200 according to an embodiment of the present inventive concept.

The vehicle 200 may include a control unit 210, an object sensing unit 220 to sense one or more objects. The vehicle 200 may include a signal/data sensing unit (or signal/data searching unit) 230 to communicate with one or more media sources to sense a signal or data as information on a site. The sensed objects and the sensed data may be collectively referred to as an event. The signal/data sensing unit 230 may be a network interface to connect the vehicle to the source. The source may be one or more sources. The sources may include a radio station or an authority announcing station which announces information on a site. It is possible that the site may have an antenna to output a site information such that the vehicle 200 can receive the site information.

The sources may include the Internet connection including the information on the site. The sources may include one or more social media with news, text, or postings. The control unit 210 control the vehicle 200 according to an instruction or information, the sensed object and/or the sensed signa/data. The control unit 210 may search for any information on a site from the sources. The control unit 210 may include one or more processors, one or more memories, and one or more interfaces. The control unit 210 may include one or more interfaces corresponding to functions of the vehicle 200 and to communicate with a user device and a control tower to manage or maintain the vehicle. The control unit 210 may control a driving unit 240 to drive the vehicle 200 along a route.

The vehicle 200 has at least one door 270 to be open and closed. The control unit 210 or the driving unit 240 may have a door lock/unlock element to lock or unlock the door 270. The control unit 210 or the driving unit 240 may have a sensor to detect states of the door such as an open state and a closed state. The door 270 may be open and closed when a passenger is in or off the vehicle 200 at a start point and an end point of a destination route or an emergency situation. The door 270 may not be unlocked during the destination route except the state and end points of the destination route. When an additional route is added to a destination route, the control unit 210 or the driving unit 240 may add a door open and close function to the additional route. The driving unit 240 may operate the vehicle 200 according to the door control during the additional route. The additional route may include a passenger pickup point, a passenger drop off point, a start point, and/or an end point so that the door is open and closed during operating the vehicle in the additional route.

The vehicle 200 may be controlled by a passenger, a program as a self-driving program with or without passenger control, a taxi with or without passenger control. The vehicle 200 may be controlled by at least one of a user device 250, a control tower 260, or another user device which is authorized by the user device 250. A user of the another user device may be another passenger to be picked up at a point or to be dropped off in the middle of the destination route. The control tower 260 and/or the control unit 210 primarily authorize the user device 250 to control the vehicle 200. However, when the user device 250 authorizes another user device for controlling the vehicle 200, the vehicle 200 may operate according to communication with the another user device together with the user device 259 and the control tower 260. The vehicle may not detect the another user device when the another user device is off the vehicle with respect to the destination route or modified route. The vehicle may further include a sensor to detect a vehicle door open or closed. The vehicle may further include a sensor or interface to detect another user device when the another device is in the vehicle and/or the vehicle is open and closed. The vehicle may recognize that a passenger is dropped off or that a new passenger is picked up in one of the destination route and the second route.

The vehicle 200 may be wirelessly connected to the user device 250 or the control tower 260. The user device 250 may be a smartphone, a cell phone, a smart watch on a user wrist, and a smart ring on a user finger. The control tower 260 may be a station to control the vehicle to set up the destination route, to communicate with the user device 250, and to control the driving unit 240 to drive a route. The vehicle 200 may generate and transmit a signal to the user device 250 and/or the control tower 260. The vehicle 200 may send or receive the signal according to at least one of the sensed objects, the sensed signal/data, and/or the controlling of the vehicle 200. The vehicle 200 may receive a user input from the user device 250 to control the vehicle 200. The user device 250 may communicate with the control tower 260 for setup a destination route between a start point and an end point, and/or for any change of the destination route.

The vehicle 200 may change a destination route to another route according to the instruction or information or the sensed objects and signal data. The control unit 210 may control the driving unit to slow down the speed of the vehicle 200 and/or to stop for pickup a passenger or for drop off a passenger in the middle of the destination route. The control unit 210 may detect a hand signal to direct vehicles 200 around the site so that the vehicle 200 can be driven according to the hand signal. It is possible that the control unit 210 may detect an authority instruction, for example, a stop sign or a slow sign, to move the vehicle 200 along a traffic line which is alternatively open to the vehicles in one direction. The control unit 210 may control the vehicle 200 to be driven along a temporarily-made traffic pattern which is not on a navigation map. Since the temporarily-built traffic pattern is changed according to a construction or a site condition, the control unit 210 may detect the objects and/or the signal/data to drive the vehicle 200. The vehicle 200 is supposed to stop at a start point such that one or more passengers get on the vehicle 200, to drive along a destination route from the start point to an end point once one or more passengers get in the vehicle 200. the vehicle 200 modifies the destination route to add an additional route, to pick up one or more additional passengers, and/or to drop off one or more passengers.

When the vehicle 200 is not driven by a user but driven by an automatic pilot program without a user control, the user may look at a user device rather than focusing the objects or the site. In this case, the vehicle 200 may communicate with the user device or a control tower to inform the user of information on the controlling of the vehicle 200, the sensed objects, and the sensed site. The user may take over the vehicle 200 from the automatic pilot program to drive the vehicle 200.

The sources may be same sources included in the user device. The vehicle 200 may include a menu to display the sources such that a user may select the sources from the menu. It is possible that the sources may be set according to a user preference or a vehicle maker. The control unit 210 searches the sources for information on the site of the destination route. The control unit 210 may receive instructions from the user device or the control tower to make the modifications to modify the destination route. An interface of the control unit 210 may communicate with the user device 250 and the control tower 260. The sensing units 220 and 230 and an interface of the control unit 210 may be collectively referred to as an interface to communicate with external networks or external devices, such as the user device 250 and the control tower 260.

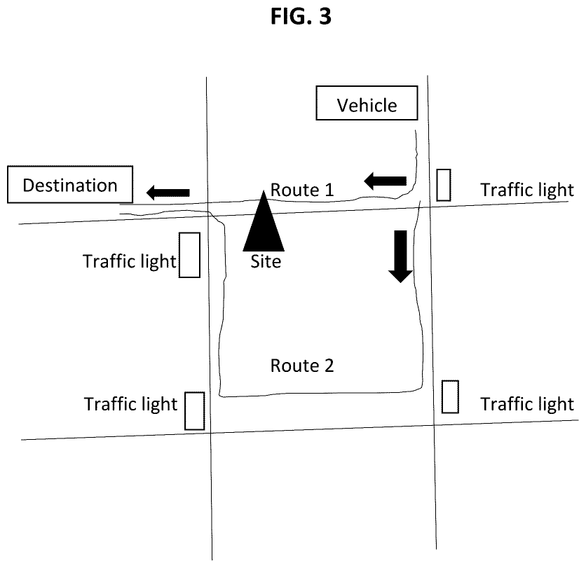

FIGS. 3 through 5 are diagrams illustrating a vehicle, objects, and data according to an embodiment of the present inventive concept.

The vehicle may be driven to a destination according to a destination route or route 1, and may also be driven according to another route or route 2 according to information on a site which is on the destination route. The traffic light may be located at an intersection. There may be one or more objects which may be sensed by the vehicle, and another one or more objects which may not be sensed by the vehicle. The one or more objects and the another one or more objects may be referred to a site or an event. When the vehicle senses or receives information on the site which is on the route 1, the vehicle is driven along the route 2 as illustrated in FIG. 3, according to the sensed objects or the sensed data as described above and hereinafter. The vehicle may not unlock the door during moving along the route 2. The vehicle may not unlock the door during moving along the route 2. The vehicle may unlock the door at a start point of the destination route to allow a user in the vehicle and at an end point of the destination route to allow the user off the vehicle. When a pickup point to pick up an additional user/passenger, a dropoff point to drop off an existing user/passenger off the vehicle, and/or a second route are added to the destination route as a combined route as described above and hereinafter, the door may be unlocked to be open and closed for the user or passenger of the combined route. The second route may include a second start point (second pickup point) and a second end point (second dropoff point). The pickup point, dropoff point, and the second route may be referred to as an additional route to be added to the destination route. Accordingly, the door may be unlocked at the start point and end point of the destination route and also at the pickup point and dropoff point of the combined route. The pickup point and the dropoff point may be in between the start and end points of the destination route. It is possible that the pickup point and the dropoff point may be at a portion of the combined route.

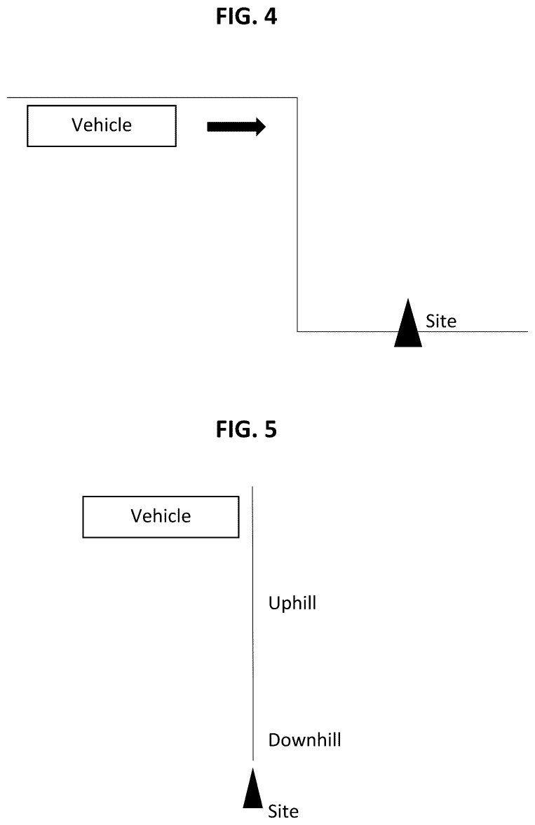

The vehicle may be driven along a route which is curved. A site may not be sensed by a sensor of the vehicle or may be out of sight or may not be seen by a user of the vehicle. The vehicle may be slow down, may prepare to stop, or may follow an instruction about the site, when the vehicle approaches the site, as illustrated in FIG. 4.

The vehicle may be driven along a route which includes an uphill and then a downhill. A site located on a down hill may be out of sight or may not be sensed by a senor of the vehicle or may not be seen by a user of the vehicle. Accordingly, the site may not be sensed by a sensor of the vehicle or may not be seen by a user of the vehicle. The vehicle may be slow down, may prepare to stop, or may follow an instruction about the site when the vehicle approaches the downhill, as illustrated in FIG. 5.

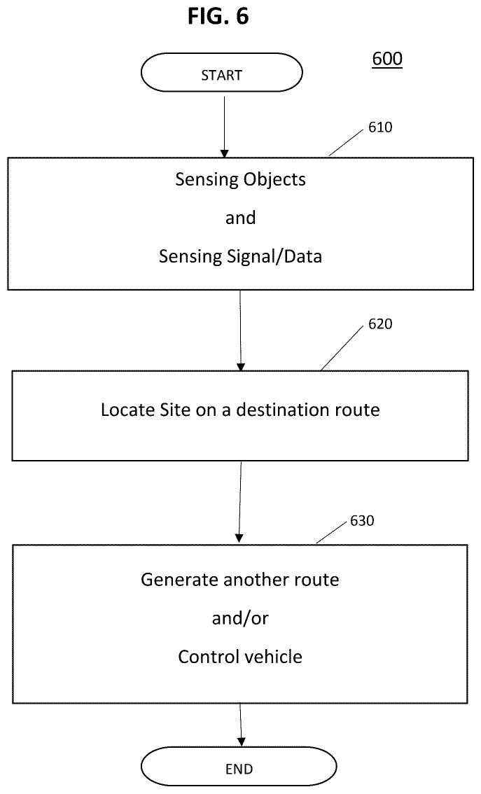

FIG. 6 is a flowchart illustrating a method 600 of controlling a vehicle according to an embodiment of the present inventive concept.

The method 600 may include an operation of sensing objects and sending signal/data relating to a site. The method 600 may include an operation of locating the site which is on a destination route. The method 600 may also include an operation 630 of generating another route to avoid the site and controlling the vehicle according to the another route. The method 600 may also include communicating with a user device and/or a control tower to inform a user of the changed route and the information on the site. The site may be an event, an accident, a pickup point in the middle of the destination route, a drop off point in the middle of the destination route, and/or additional point corresponding to additional route. It is possible that the additional point may overlap the destination route. The additional point may be off the destination route.

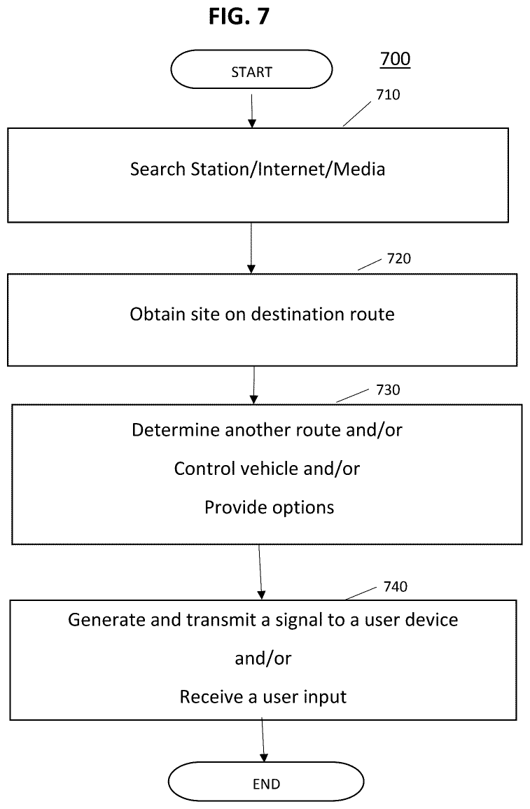

FIG. 7 is a flowchart illustrating a method 700 of controlling a vehicle according to an embodiment of the present inventive concept.

The method 700 may include an operation 710 of searching one or more sources, for example, a radio station, a traffic condition announcer, an internet, a social media, a news media, etc. The method 700 may include an operation 720 search for any words or any voices relating to a site on a destination route. The vehicle may include a unit to extract a text or a voice, which relates to the site, from the words and voices from the sources. The method 700 may include an operation 730 of extracting a text or voice and obtaining the site of the destination route. The method 700 may include an operation 740 of determining another route, controlling the vehicle, and communicating with a user device and/or a control tower and receiving a user input from the user device and/or the control tower.

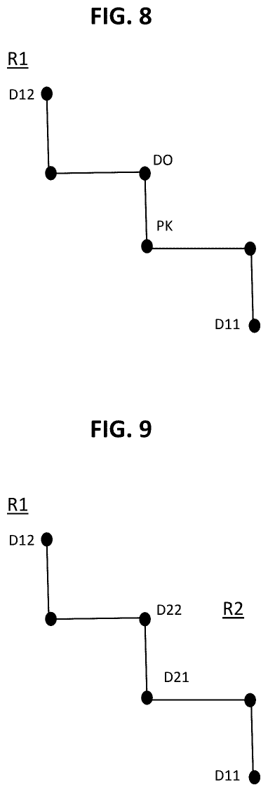

FIGS. 8 through 12 are diagrams illustrating a route and another route with additional information according to an embodiment of the present inventive concept.

FIG. 8 illustrates a destination route R1 of a vehicle from a start point D11 to an end point D12. The vehicle may stop to pick up additional passenger at a pick-up point PK or to drop off one of passengers at a drop-off point DO in the middle of the driving the vehicle along the destination route R1. It is possible that a user device may enter the pickup point PK or the dropoff point into a control tower or the vehicle before or after starting driving along the destination route R1. Once the vehicle stops for the pickup or dropoff, the vehicle keeps driving along a remaining portion of the destination route R1. The vehicle may recognize that the passenger is picked up or dropped off when a door of the vehicle is open and closed at the pickup point PK or the dropoff point DO. Once the vehicle recognizes the pickup or dropoff, the vehicle keeps driving along a remaining portion of the destination route R1. It is possible that the vehicle may recognize that the passenger is picked up or dropped off when another user device of the passenger is detected to be in or off the vehicle.

The control unit may recognize completion of a starting point and an end point of the second route according to detection of the door of the vehicle open and closed at the start and end points. When the control unit recognizes or detects the completion of the points and/or the detection of states of the door, the control unit controls the driving unit to keep moving the vehicle along a remaining route. The vehicle may unlock the door to be open and closed at a start point and an end point of the destination route. The vehicle may also unlock the door to be open and closed at a pickup point and a dropoff point. The vehicle may recognize that a passenger is in or off the vehicle when the door is open and closed so that the vehicle can keep moving along the destination route or the second route. It is possible that the vehicle may recognize that a passenger is in or off the vehicle when detecting a user device. Upon recognizing or detecting a state of the door and the user device, the vehicle may keep moving along the destination route or the second route.

FIG. 9 illustrates a destination route R1 and a second route R2 according to an embodiment of the present inventive concept. The vehicle is supposed to drive along the destination route R1 from a start point D11 to an end point D12. When the vehicle receives an instruction or information about a second route R2 with a second starting point D21 and a second end point D22. A control tower or a user device may determine that the second route R2 is added to the destination route R1. The second route R2 may be a portion of the destination route R1. The second route R2 may overlap with the destination route R1. A passenger of the second route R2 may join a passenger of the destination route R1 and share riding of the vehicle for the second route R2. Once the vehicle stops to pick up the passenger of the second route R2, the vehicle keeps driving along a remaining portion of the destination route R1. The vehicle may recognize that the passenger of the second route R2 is picked up or dropped off when a door of the vehicle is open and closed at the second start point D21 or the second end point D22. Once the vehicle recognizes the pickup or dropoff, the vehicle keeps driving along a remaining portion of the destination route R1. It is possible that the vehicle may recognize that the passenger is picked up or dropped off when another user device of the passenger is detected to be in or off the vehicle.

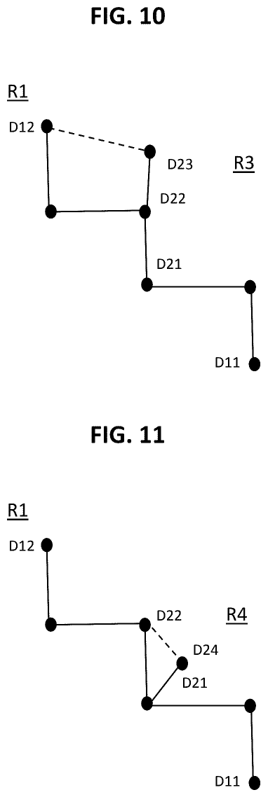

FIG. 10 illustrates a destination route R1 and a third route R3 according to an embodiment of the present inventive concept. The vehicle is supposed to drive along the destination route R1 from a start point D11 to an end point D12. When the vehicle receives an instruction or information about a third route R3 with a second starting point D21 and a third end point D23. A control tower or a user device may determine that the third route R2 is added to the destination route R1. At least a portion of the third route R3 may be a portion of the destination route R1. A portion of the third route R3 may overlap with a portion of the destination route R1. A passenger of the third route R3 may join a passenger of the destination route R1 and share riding of the vehicle for the third route R3. The vehicle may be off the destination route R1 to get the third end point D23. The vehicle may be back from the third end point D23 to the second end point D22 of the destination route R1 to continue driving of a remaining portion of the destination route R1. It is possible that the vehicle may be on a track from the third end point D23 to the end point D12 or a point between the third end point D23 and the end point D12. the second end point D22 of the destination route R1 to continue driving of a remaining portion of the destination route R1. Once the vehicle stops to pick up the passenger of the third route R3, the vehicle keeps driving along a remaining portion of the destination route R1. The vehicle may recognize that the passenger of the third route R3 is picked up or dropped off when a door of the vehicle is open and closed at the second start point D21 or the third end point D23. Once the vehicle recognizes the pickup or dropoff, the vehicle keeps driving along a remaining portion of the destination route R1. It is possible that the vehicle may recognize that the passenger is picked up or dropped off when another user device of the passenger is detected to be in or off the vehicle.

FIG. 11 illustrates a destination route R1 and a fourth route R4 according to an embodiment of the present inventive concept. The vehicle is supposed to drive along the destination route R1 from a start point D11 to an end point D12. When the vehicle receives an instruction or information about a fourth route R4 with a third starting point D24 and a second end point D22. A control tower or a user device may determine that the fourth route R4 is added to the destination route R1. At least a portion of the fourth route R4 may be a portion of the destination route R1. A portion of the fourth route R4 may overlap with a portion of the destination route R1. A passenger of the fourth route R4 may join a passenger of the destination route R1 and share riding of the vehicle for the fourth route R4. The vehicle may be off the destination route R1 to get the third starting point D24. The vehicle may be back from the third start point D24 to the second start point D21 of the destination route R1 to continue driving of a remaining portion of the destination route R1. It is possible that the vehicle may be on a track from the third start point D24 to the second end point D22 or a point between the third start point D24 and the second end point D22. Once the vehicle stops to pick up the passenger of the fourth route R4, the vehicle keeps driving along a remaining portion of the destination route R1. The vehicle may recognize that the passenger of the fourth route R4 is picked up or dropped off when a door of the vehicle is open and closed at the third start point D24 or the second start point D22. Once the vehicle recognizes the pickup or dropoff, the vehicle keeps driving along a remaining portion of the destination route R1. It is possible that the vehicle may recognize that the passenger is picked up or dropped off when the vehicle detects or disconnected from another user device of the passenger or when the vehicle recognizes that the another user device is detected to be in or off the vehicle.

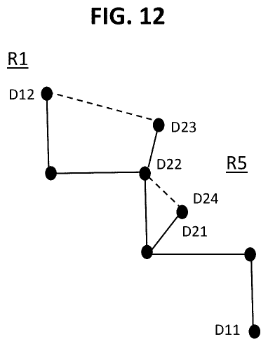

FIG. 12 illustrates a destination route R1 and a fifth route R5 according to an embodiment of the present inventive concept. FIG. 12 may be an illustration of a combination of routes of FIG. 10 and FIG. 11. The vehicle is supposed to drive along the destination route R1 from a start point D11 to an end point D12. When the vehicle receives an instruction or information about a fifth route R5 with a third starting point D24 and a third end point D23. A control tower or a user device may determine that the fifth route R25 is added to the destination route R1. At least a portion of the fifth route R5 may be a portion of the destination route R1. A portion of the fifth route R5 may overlap with a portion of the destination route R1. A passenger of the fifth route R5 may join a passenger of the destination route R1 and share riding of the vehicle for the fifth route R5. The vehicle may be off the destination route R1 to get the third starting point D24 and the third end point D23. The vehicle may be back from the third start point D24 to the second start point D21 of the destination route R1 to continue driving of a remaining portion of the destination route R1. The vehicle may be back from the third end point D23 to the second end point D22 of the destination route R1 to continue driving of a remaining portion of the destination route R1. It is possible that the vehicle may be on a track from the third start point D24 to the send end point D22 or a point between the third start point D24 and the second end point D22. It is possible that the vehicle may be on a track from the third end point D23 to the end point D12, or a point between the third end point D23 and the end point D12 to continue driving of a remaining portion of the destination route R1. Once the vehicle stops to pick up the passenger of the fifth route R5, the vehicle keeps driving along a remaining portion of the destination route R1. The vehicle may recognize that the passenger of the fifth route R5 is picked up or dropped off when a door of the vehicle is open and closed at the third start point D24 or the third end point D23. Once the vehicle recognizes the pickup or dropoff, the vehicle keeps driving along a remaining portion of the destination route R1. It is possible that the vehicle may recognize that the passenger is picked up or dropped off when the vehicle detects or disconnected from another user device of the passenger or when the vehicle recognizes that the another user device is detected to be in or off the vehicle.

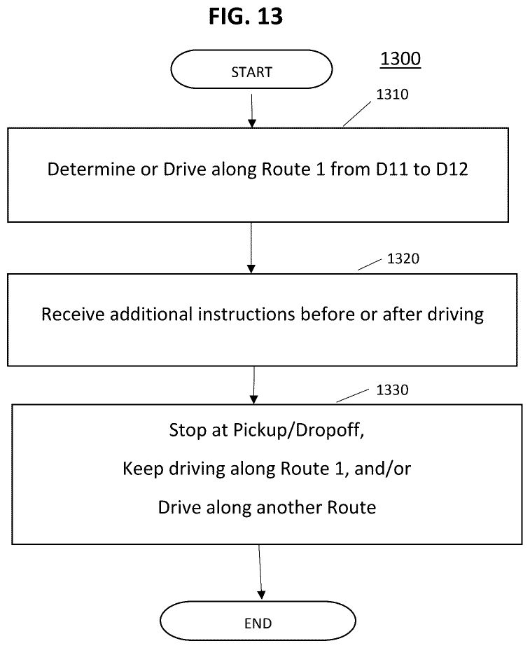

FIG. 13 is a flowchart illustrating a method 1300 of controlling a vehicle according to an embodiment of the present inventive concept.

The method 1300 may include an operation 1310 of determining or driving along a destination route R1 from a point D11 to a point D12 as illustrated in FIG. 8. The destination route may have a door control at start and end points of the destination route. The destination route may not have the door control between the start and end points of the destination route.

The method 1300 may further include an operation 1320 of receiving addition instructions or information before or after starting driving along the destination route R1. The additional instructions may include an additional route with a door control to pick up or drop off a passenger. The additional route is added to the destination route as a combined route. The method 1300 may further include an operation 1330 of stopping at pickup or dropoff point as illustrated in FIGS. 8 and 9, returning to the destination route R1 from another route as illustrated in FIGS. 8 through 12, or keeping driving along the destination route R1 as illustrated in FIGS. 8 through 12. Another route may be generated according to the sensed objects and data as an event. The another route may not have the door control. The another route may be added to the combined route.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a read-only memory (ROM), a random-access memory (RAM), a flash memory, a semiconductor chip package, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A vehicle having a door, comprising:
an object sensing unit to sense to sense one or more objects;
a data sensing unit to wirelessly communicate with a media source to sense a data;
a driving unit to operate the vehicle according to the sensed one or more objects and the sensed data;
an interface to communicate with at least one of a user device and a control tower to receive an additional route; and
a control unit to perform a door control to be open and closed at start and end points of a destination route, to add an additional route with an additional door control to the destination route as a combined route, to control the driving unit to operate the vehicle according to the combined route, and to control the door to be open and closed in the additional route of the combined route.

2. The vehicle of claim 1, wherein the control unit generates another route without the control of the door according to at least one of the sensed one or more objects and the sensed data, and the control unit controls the driving unit to drive the vehicle according to the another route and the combined route.

3. The vehicle of claim 1, wherein the destination route does not have the control of the door between the start and end points of the destination route.

4. The vehicle of claim 1, wherein the additional route comprises a pickup point to pick up a passenger, and the door is open and closed at the pickup point.

5. The vehicle of claim 1, wherein the additional route comprises a drop off point to drop off pick up a passenger, and the door is open and closed at the drop off point.

6. The vehicle of claim 1, wherein the additional route is determined by the at least one of the user device and the control center.

7. The vehicle of claim 1, wherein a portion of the additional route overlaps a portion of the destination route.

8. The vehicle of claim 1, wherein the additional route comprises a start point and an end point at least one of which is included in the destination route.

9. The vehicle of claim 1, wherein the additional route comprises a start point and an end point which are off the destination route.

10. The vehicle of claim 1, wherein the control unit controls the vehicle to be returned to the destination route from the additional route in the combined route.

11. The vehicle of claim 1, wherein the driving unit controls the vehicle according to at least one of the sensed objects and the sensed data.

12. The vehicle of claim 1, wherein the driving unit controls the vehicle to be temporality off and on the combined route according to at least one of the sensed objects and the sensed data.

13. The vehicle of claim 1, wherein the additional route is combined with the destination route as the combined route according to a user input from the user device.

14. The vehicle of claim 1, wherein the additional route is generated by the control center and determined by the user device to be added to the destination route.

15. The vehicle of claim 1, wherein the data comprises at least one of a new traffic data, a new traffic pattern, and a new traffic line which are not included in a navigation map of the destination route and the additional route.

16. The vehicle of claim 1, wherein the one or more objects output a signal according to a protocol such that the object sensing unit senses a state of the one or more objects from the signal.

17. The vehicle of claim 1, wherein the media source comprises at least one of a wireless station, an internet, a social media, and the control tower.

18. The vehicle of claim 1, wherein the destination route comprises an end point and an arrival time of the end point, and the interface communicates with an external deice on information of an adjusted arrival time according to the combined route.

19. The vehicle of claim 1, wherein:
the state of the door comprises a door open state and a door closed state; and
the driving unit continues to operate the vehicle along a remaining portion of the combined route after recognizing completion of a starting point or an end point of the additional route according to the door open or closed states at the start and end points of the additional route.

20. The vehicle of claim 1, wherein the control unit further controls the driving unit to operate the vehicle without the state of the door in the combined route except start and end points of the additional route.
